(19) United States
(12) Patent Application Publication
(10) Pub. No.: US 2009/0090016 A1
(43) Pub. Date: Apr. 9, 2009

(54) TAPE MEASURE WITH AFFIXED WRITING SURFACE

(76) Inventor: Brian Roach, (US)

Correspondence Address: David Milosevic, 185 Carlton, Toronto, M5A 2K7, omitted

(21) Appl. No.: 11/868,029

(22) Filed: Oct. 5, 2007

(51) Int. Cl. G01B 3/10; G01B 3/02

(52) U.S. Cl. 33/770; 33/771

(57) ABSTRACT

One embodiment of a tape measure with a writing surface 2 on the retractable plastic or metal retractable strip onto which are printed units of measurement. The writing surface 2 is made of plastic that allows for ease of writing and eraseability. Other embodiments are described.

### CROSS REFERENCE TO RELATED APPLICATIONS

None

### FEDERALLY SPONSORED RESEARCH

Not applicable

### BACKGROUND OF THE INVENTION

1. Field of the Invention

This invention generally relates to tape measures, more particularly, to an improved and expanded functionality for a tape measure having a blank writing surface running down the center of the retractable strip to allow for writing directly on the retractable strip.

2. Prior Art

Hand held tape measures are typically used to measure distances between points. For example, workmen and others use tape measures to measure a length of lumber, or pipes, or other materials. Tape measures are also commonly used to measure the dimensions of various articles and room dimensions.

A conventional tape measure normally has a metal or plastic housing, within which is contained a flexible plastic or metal strip wound around a shaft. Often the shaft is spring loaded, allowing for easy retraction of the strip. The retractable strip surface is normally printed with units of measurement in various increments, either metric, or imperial, or both.

### SUMMARY

In accordance with one embodiment, the present invention allows for increased functionality of existing tape measures by allowing users to write directly on the retractable strip. To allow for such writing, a blank writing surface would be affixed to the retractable strip, running down its center. The writing surface would be of a width that would allow units of measurement to be clearly visible on each side of the writing surface.

Another embodiment of the present invention comprises a writing surface that is incorporated directly into the retractable strip, and not affixed thereto. In this embodiment, the manufacturing of the strip includes the writing surface at the center of the strip.

Yet another embodiment of the present invention includes a writing strip placed along the left hand or right hand side of the retractable strip.

Yet another embodiment of the present invention comprises a writing surface along the back of the retractable strip or a writing surface over the entire back of the retractable strip.

The advantage of the present invention is that measurements or intervals can be marked directly on the tape measure's retractable strip, rather than on the surface of the material being measured. This is particularly advantageous where the article being measured cannot easily be marked, or where measurements need to be recorded for ease of reference.

### DRAWINGS—FIGURES

FIG. 1 is the housing of a tape measure which contains the retractable strip and any shaft and spring mechanism allowing for ease of retraction of the strip.

FIG. 2 is the writing surface affixed or incorporated into the retractable strip.

FIG. 3 is the plastic or metal retractable strip onto which are printed units of measurement,

### DRAWINGS—REFERENCE NUMERALS

1 Tape measure housing

2 Writing surface

3 Retractable strip with units of measurement

### DETAILED DESCRIPTION—FIRST EMBODYMENT—FIGS

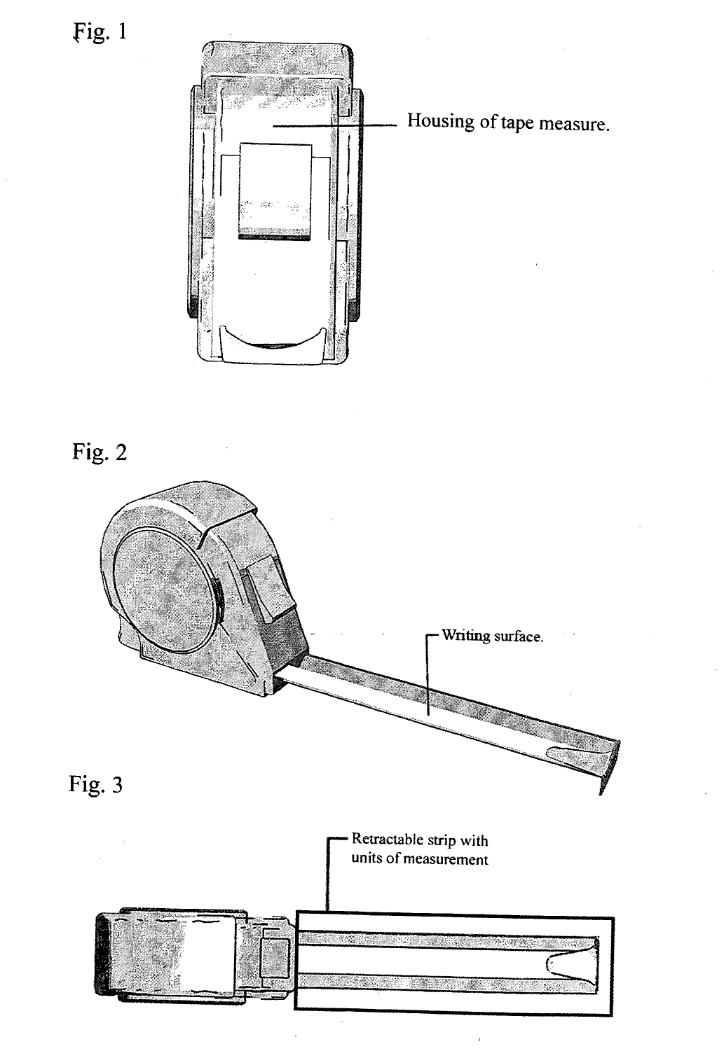

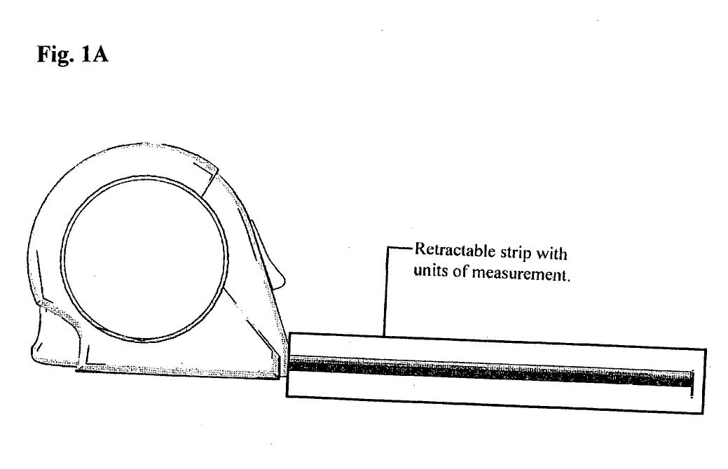

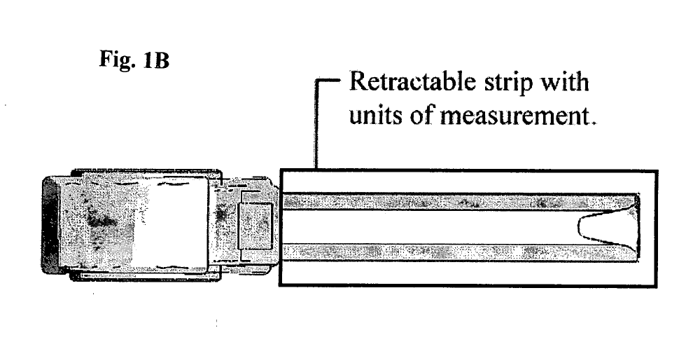

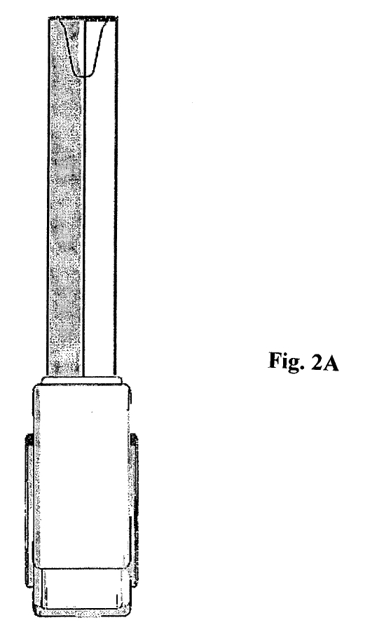

One embodiment of the writing surface is illustrated in FIG. 1A (front view) and FIG. 2A (top view). The writing surface 2 can be seen running down the center of the retractable strip 3. The writing surface 2 is narrow, and occupies approximately ⅓ of the total width of the retractable strip 3. In the preferred embodiment, the writing surface is erasable, textured plastic, which can be written on by both ink and pencil or marker. However, the writing surface can consist of any other material upon which marks can be made and erased.

There are various possibilities with regard to the placement of the writing surface. The writing surface can be located in the center of the retractable strip, as illustrated in FIG. 1A and FIG. 1B. Alternatively, the writing surface can be located along either the right and or left hand side of the retractable strip, or along part of the back of the retractable strip, or even comprise the entire back or front surface of the retractable strip. For example, a clear writing surface can be placed over the top of the retractable writing strip, allowing for easy view of the measuring surface of the retractable strip as well as writing upon the clear surface.

### Operation—First Emobodyment—FIGS

The manner of using the writing surface is straightforward. One using a tape measure and requiring a record of the distance measured simply writes on the writing surface 2 to record the required measurement. Many different measurements can be recorded, limited only by the available space on the writing surface 2. Once written records of measurements are no longer needed, they can be easily erased from the writing surface 2.

### Conclusions, Ramiications, and Scope

Accordingly, the reader will see that, according to one embodiment of the invention I have provided, the writing surface runs down the center of the retractable strip. While the above description contains a number of specifications, these should not be construed as limitations on the scope of any embodiment, but as exemplifications of the presently preferred embodiments thereof. Many other ramifications and variations are possible within the teachings of the various embodiments. For example the placement of the writing surface can be varied, as can its size and the material used to make the writing surface. Thus the scope of the invention should be determined by the appended claims and their legal equivalents, and not by the examples given.

I claim:

1. In a tape measure of a type normally comprising a metal or plastic housing, within which is contained a flexible plastic or metal strip wound around a shaft said flexible strip being printed with units of measurement the improvement wherein said flexible strip includes a writing surface.

2. The flexible strip with writing surface affixed of claim 1 wherein the writing surface is made of erasable plastic runs down the center of the flexible strip
